(19) United States
(12) Patent Application Publication
(10) Pub. No.: US 2011/0068058 A1
(43) Pub. Date: Mar. 24, 2011

(54) APPARATUS AND PROCESS FOR TREATING WASTEWATER

(75) Inventor: Youfeng Sun, Beijing (CN)

(73) Assignee: BEIJING ECOJOY WATER TECHNOLOGY CO., LTD., Beijing (CN)

(21) Appl. No.: 12/993,782

(22) PCT Filed: May 8, 2009
(86) PCT No.: PCT/CN09/71685

§ 371 Date: Nov. 19, 2010

(30) Foreign Application Priority Data
May 20, 2008 (CN) 200810111976.0

(51) Int. Cl. C02F 3/12

(52) U.S. Cl. 210/620; 210/206

(57) ABSTRACT

An apparatus for treating wastewater is provided, which comprises a biological reaction tank and a membrane separation device. The membrane separation device is provided outside the biological reaction tank. A mixing device is provided inside the biological reaction tank and an aeration device is provided inside the membrane separation device or inside a container for loading the membrane separation device. The biological reaction tank is connected to the membrane separation device or the container for loading the membrane separation device through a pipeline. A process using the apparatus for treating wastewater is also provided.

This application claims priority to Chinese Patent Application No. 200810111976.0, filed with the Chinese Intellectual Property Office on May 20, 2008, entitled “APPARATUS AND PROCESS FOR TREATING WASTEWATER”, which is hereby incorporated by reference in its entirety.

### FIELD OF INVENTION

The invention relates to an equipment and process for wastewater treatment, and in particular to an equipment and process for wastewater treatment using membrane bioreactor technology, which belong to the field of water treatment technology.

### BACKGROUND OF THE INVENTION

Membrane bioreactor (MBR) technology is a highly efficient wastewater treatment and reclamation technology which combines a membrane separation technology with a traditional biological treatment technology. In a MBR system, various contaminants in wastewater are mainly removed by biochemical reaction of microorganism. However, different from traditional biological treatment process, the membrane separation device has taken the place of secondary sedimentation tank to thoroughly separate sludge and water by its highly efficient separation function. This enables sludge retention time which is also referred to as biosolid retention time (SRT) and hydraulic retention time (HRT) to be controlled independent from each other. Besides, the increase in concentration of active sludge in the biological reaction tank and accumulation of specific bacteria in the active sludge has improved the rate of biochemical reaction. Instead of implementing the separation between the microorganism and water through gravitational sedimentation, under the drive of pressure, water molecules and some other small-molecule substance permeate the membrane, while microorganism and big-molecule substance are intercepted in the biological reaction tank by the membrane, so that the system obtains excellent effluent quality. The MBR technology substantially solves the prominent problems of unstable effluent quality, large footprint and complicated processing control, etc, which are commonly found in traditional wastewater treatment process, and is a water treatment technology with great development potential. Especially in the field of wastewater reclamation and reuse, domestic wastewater, municipal wastewater or similar industrial wastewater may be treated through MBR technology in one step into high quality recycled water to be used as municipal miscellaneous water, industrial circulating cooling water, etc. Currently, the MBR technology is drawing more and more worldwide academic attention, and large-scale engineering applications are gradually increasing.

According to the position where the membrane separation device is arranged, the MBR can be divided into an external MBR (or referred to as side stream MBR, separate MBR) and an internal MBR (or referred to as immersed MBR, integrative MBR and submerged MBR).

The external MBR is an early development modality of MBR technology since its birth in 1960s, wherein a membrane separation device and a bioreactor are separately arranged. Mixed liquor in the bioreactor, after being pressurized by a circulating pump, is conveyed to the feed-liquid entrance of the membrane separation device. Liquid in the mixed liquor permeates the membrane under pressure and becomes the effluent of the system, while solids, big-molecule substances etc are intercepted by the membrane and flow back into the bioreactor with concentrate. The characteristic of the external MBR lies in that it runs stably and reliably, the membrane separation device is easy to clean, replace and add, and the membrane flux is generally large. However, under general conditions, in order to reduce deposition of pollutants on membrane surface and to extend the cleaning period of membrane, a circulating pump is required to provide a high cross-flow velocity of membrane surface, which results in an increase in water flow circulating amount and required pump lift of the circulating pump, an increase in power expense. Besides, the energy consumption per ton water can reach 2-10 kWh/m³, and the shear force generated by the high speed rotation of pump will make some microorganism thallus deactivation.

The internal MBR has developed from late 1980s and has gradually become the main modality of current MBR technology. The internal MBR submerges the membrane separation device below the liquid level of bioreactor. After the raw water enters the bioreactor, most contaminants therein are decomposed or transformed by active sludge in the mixed liquor, and then, under the negative pressure provided by a suction pump or under the effect of water level difference, treated water are filtered out through the membrane. An aeration system is provided under the membrane modules to, on one hand, provide oxygen necessary for microorganism to decompose organism, and on the other hand, make use of the principle of gas stripping so that two-phase flow of gas and water performs hydraulic washing on the outer surface of the membrane to inhibit deposition of sludge layer on the membrane surface. As compared to the external MBR, the internal MBR has omitted mixed liquor circulating system, such that the structure is more compact and the footprint is smaller. Furthermore, due to treated water achieved by negative pressure suction or water level difference in the internal MBR, energy consumption per ton water is relatively low, which can be reduced to 1-2.4 kWh/m³. The biological reaction tank in the present invention can also be referred to as bioreactor.

Although the MBR employed in most of current practical projects in the world is the internal MBR process, there are two prominent problems with the internal MBR. Firstly, the installation, maintenance and cleaning of the membrane separation device is inconvenient and the labor intensity of cleaning is heavy. Secondly, the amount of aeration is relatively large, wherein the ratio of gas to water is 30-40:1, which is 3-4 times larger of other existing and relatively mature biological wastewater treatment processes, such as conventional active sludge process, sequencing batch reactor process, etc, and which makes the energy consumption per ton water significantly higher than other processes. Meanwhile, since the manufacturing cost of existing membrane separation device is relatively high, the basic constructive investment of MBR process is significantly higher than other processes. The above three prominent problems make it currently difficult for MRB process to replace prior art to become one of the main technologies in the field of water treatment.

In order to further reduce aeration energy consumption of the internal MBR and to facilitate installation, maintenance and cleaning of membrane separation device, another kind of external MRB has been developed in recent years, such as Chinese patent and patent applications 01123900.X, 200410039006.6, 200510069410.2 and 200710064736.5. The configuration of this kind of MBR is similar to that of conventional external MBR. The selected membrane separation device composed of curtain or bundle type of hollow fiber membrane modules is submerged into another smaller membrane filter tank (box) which is independent from bioreactor and dedicated to install membrane modules. Alternatively, this kind of MBR selects a membrane separation device with enclosed housing, which is commonly found in conventional external MBR and composed of column type of hollow fiber membrane modules or tube type of membrane modules. However, different from conventional external MBR, the treated water of the system is not obtained by means of pressurization by circulating pump, and but is obtained by negative pressure provided by an additional suction pump so that the flow and pump lift of the circulating pump is significantly reduced. Meanwhile, an aeration component is provided in the membrane filter tank (box) or the membrane separation device with enclosed housing. Since the area occupied by the membrane modules is significantly reduced as compare to conventional internal MBR, the gas stripping section is also significantly reduced accordingly, so that a higher aeration intensity can be obtained with a smaller aeration amount in the area where the membrane modules are installed. Therefore, a two-phase flow of gas and water have a better hydraulic washing effect on the outer surface of membrane, can inhibit the development of membrane fouling preferably, and saves aeration energy consumption to some extent, which make the overall system energy consumption lower than conventional internal MBR. However, since the outer modality of conventional external MBR is employed in which the membrane separation device is installed outside the bioreactor, the problems of being difficult to clean and wash when the membrane separation device is submerged below the liquid level of bioreactor are avoided, and an on-line chemical agent soaking cleaning of the membrane separation device is facilitated. As compare to the situation of conventional internal MBR in which the membrane separation device must be lifted up from the bioreactor by a hoisting device and then put into an external medical liquid tank for off-line chemical agent soaking, the on-line chemical agent soaking cleaning not only lowers the labor intensity significantly, but also decreases the amount of cleaning agent so that the problems of wasting and disposing of chemical agent are avoided, and the installation, maintenance and cleaning of membrane separation device is facilitated to a large extent. Therefore, this kind of MBR can combine internal MBR and external MBR, get their strong points and offset their weaknesses. As compared to conventional external MBR which obtains treated water of system by positive pressure, this new type of external MBR obtains treated water of system by negative pressure. Therefore, these two types of external MBR can be referred to as “positive pressure external MBR” and “negative pressure external MBR” respectively to differentiate from each other.

Although the gas/water ratio (i.e., 15-20:1) of the negative pressure external MBR is reduced by about one half as compared to conventional internal MBR, it is still higher than that of other biological wastewater treatment process such as conventional active sludge process, etc (i.e., 7-10:1). This is mainly because even though a surface cross-flow is provided for the membrane modules by aeration inside the membrane filter tank (box) or inside the membrane separation device with an enclosed housing whose gas stripping section has significantly reduced, the corresponding gas/water ratio is usually as large as 7-15:1. Since the bioreactor which serves as the main functional unit for removing organic pollutants still needs an amount of aeration which corresponds to a gas/water ratio of 5-10:1 to fulfill the carbon oxidation and nitrification process, and the bioreactor also needs to realize adequate mixing and contact of wastewater, active microorganism and oxygen using aeration as an agitating means, the overall amount of aeration of negative pressure external MBR is still high, which makes the negative pressure external MBR disadvantageous in energy consumption per ton water, and in particular restricts its popularization and application in large-scale wastewater treatment projects.

### SUMMARY OF THE INVENTION

The objective of the invention is to provide an equipment for wastewater treatment, whereby the operational energy consumption of MBR wastewater treatment system can be further reduced.

The following technical solution is adopted in order to achieve the above objective:

A wastewater treatment equipment, comprising a biological reaction tank and a membrane separation device, the membrane separation device is provided outside the biological reaction tank, a mixing device is provided inside the biological reaction tank, and an aeration device is provided inside the membrane separation device or inside a container for accommodating the membrane separation device, the membrane separation device or the container for accommodating the membrane separation device is connected to the biological reaction tank through a pipeline.

Preferably, the membrane separation device is provided inside a membrane filter tank which is independent from the biological reaction tank, the membrane filter tank is connected to the biological reaction tank through the pipeline.

Preferably, the membrane separation device has an enclosed housing, a feed-liquid inlet and a feed-liquid outlet, the feed-liquid inlet and the feed-liquid outlet are connected to the biological reaction tank through the pipeline.

Preferably, there are two said pipelines, one of which is connected to an upper portion of the biological reaction tank, and the other of which is connected to a lower portion of the biological reaction tank.

Preferably, there are two said pipelines, one of which is connected to the biological reaction tank at an upstream of water flow direction in the biological reaction tank, and the other of which is connected to the biological reaction tank at a downstream of water flow direction in the biological reaction tank.

Preferably, the mixing device is a water distribution device.

Preferably, the water distribution device is a branch or annular shape water distribution pipe network composed of a plurality of perforated pipes.

Preferably, the water distribution device is located at the lower portion of the biological reaction tank.

Preferably, the mixing device is an agitating device.

Preferably, the agitating device is a submersible agitator or a vertical agitator.

Preferably, the mixing device is a mechanical aeration device.

Preferably, the mechanical aeration device is a rotating brush aerator, a rotating disc aerator, a vertical surface aerator or a submersible aerator.

Preferably, the aeration device is provided inside the biological reaction tank.

Preferably, the aeration device inside the biological reaction tank is located at a lower portion of the biological reaction tank, a straight line ascending distance of gas discharged from the aeration device inside the biological reaction tank is larger than one half of the effective water depth of the biological reaction tank.

Preferably, the biological reaction tank has one or two partition walls therein, which divide the biological reaction tank into two or three areas, the mixing device and the aeration device inside the biological reaction tank are located in the different areas.

Preferably, a circulating pump is provided in the pipeline.

Preferably, an outflow pump is provided in the pipeline which is connected to a permeated liquid outlet of the membrane separation device.

Preferably, the membrane separation device comprises a plurality of hollow fiber type membrane modules, plate and frame type membrane modules or tube type membrane modules.

Preferably, the membrane module is a microfiltration membrane, ultrafiltration membrane or nanofiltration membrane.

The invention also provides a wastewater treatment process, comprising the following steps of:

a) directing wastewater which is to be treated into a biological reaction tank which has active microorganism therein;

b) directing a mixed liquor composed of the wastewater and the active microorganism in the biological reaction tank into a membrane separation device or a container for accommodating the membrane separation device to perform solid-liquid separation operation on the active microorganism and water, an aeration device provided inside the membrane separation device or the container for accommodating the membrane separation device aerating the mixed liquor during the solid-liquid separation operation;

c) directing a concentrate generated inside the membrane separation device or the container for accommodating the membrane separation device during the solid-liquid separation operation into the biological reaction tank, a mixing device provided inside the biological reaction tank uniformly mixing the concentrate with the mixed liquor inside the biological reaction tank.

In the present invention, as compared to the prior art, there is a circulating flow of mixed liquor between the biological reaction tank and the membrane separation device or the container for accommodating the membrane separation device. Furthermore, a concentrate flows back to the biological reaction tank from the membrane separation device or the container for accommodating the membrane separation device under the action of the mixing device provided inside the biological reaction tank, to sufficiently mix with the mixed liquor in the biological reaction tank. Accordingly, the concentrate with a high dissolved oxygen concentration (generally as high as 3-5 mg/L) flowing back from the membrane separation device or the container for accommodating the membrane separation device complements oxygen required for biochemical reaction of microorganism in the mixed liquor in the biological reaction tank. By comparison, in the prior art negative pressure external MBR, the backflowing concentrate falls into the upper portion of the biological reaction tank directly from the feed-liquid outlet of the membrane separation device or the upper portion of the container for accommodating the membrane separation device using a residual pumping head or water level difference and cannot sufficiently mix with the mixed liquor at the lower portion of the biological reaction tank. In another way, the prior art negative pressure external MBR is to connect the pipeline for conveying the concentrate to the lower portion of the biological reaction tank under the action of a circulating pump. However, it can merely realize a local incomplete mix. In particular, in a large-scale wastewater treatment project where the biological reaction tank is a large-size open construction, it is impossible to make effective use of high concentration dissolved oxygen in the concentrate without a dedicated mixing device. In the present invention, a mixing device is provided inside the biological reaction tank so as to sufficiently mix the concentrate with the mixed liquor in the biological reaction tank, thus avoiding a waste of high intensity aeration energy consumption in the membrane filter tank, which is commonly found in the prior art negative pressure external MBR. Therefore, on the whole, the gas/water ratio of the MBR is reduced below 12:1 or even below 10:1, which is substantially close to that of other biological wastewater treatment processes such as conventional active sludge process, etc, so that the operational energy consumption of MBR wastewater treatment system can be maintained at a low level.

### BRIEF DESCRIPTION OF THE DRAWINGS

FIG. 1 is a schematic view showing the process flowchart of a wastewater treatment equipment according to a first embodiment of the invention;

FIG. 2 is a schematic view showing the process flowchart of a wastewater treatment equipment according to a second embodiment of the invention;

FIG. 3 is a schematic view showing the process flowchart of a wastewater treatment equipment according to a third embodiment of the invention;

FIG. 4 is a schematic view showing the planar arrangement of a wastewater treatment equipment according to a first embodiment of the invention;

FIG. 5 is a schematic view showing the planar arrangement of a wastewater treatment equipment according to a second embodiment of the invention;

FIG. 6 is a schematic view showing the planar arrangement of a wastewater treatment equipment according to a third embodiment of the invention;

FIG. 7 is a schematic view showing the process operational procedure of a wastewater treatment equipment according to a first embodiment of the invention;

FIG. 8 is a schematic view showing the process operational procedure of a wastewater treatment equipment according to a second embodiment of the invention;

FIG. 9 is a schematic view showing the process operational procedure of a wastewater treatment equipment according to a third embodiment of the invention.

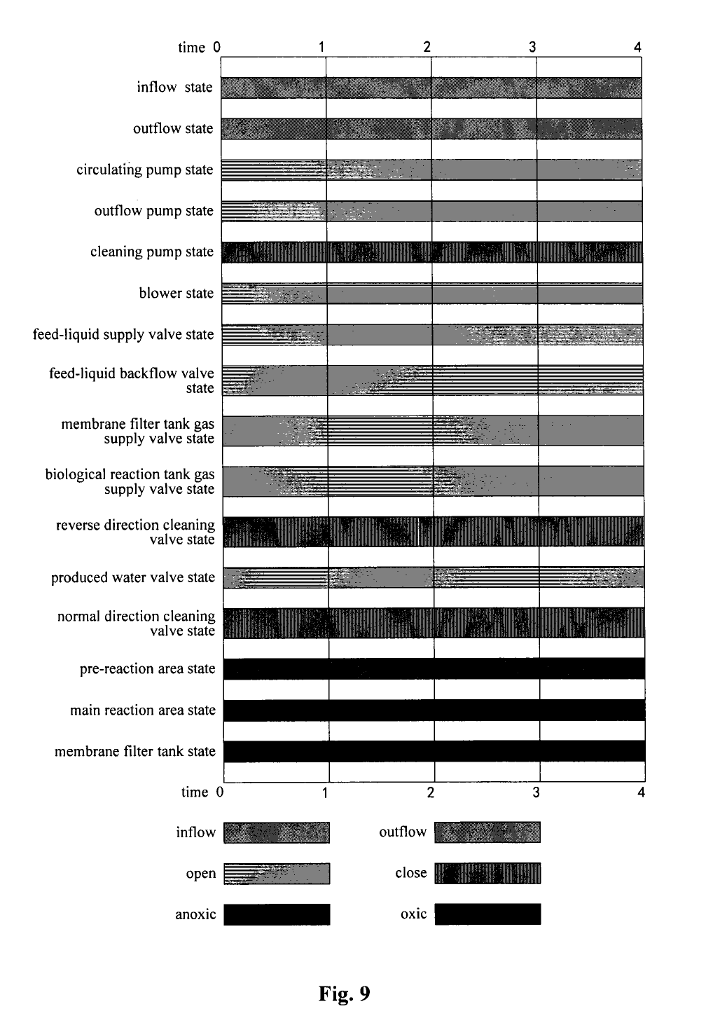

### NOTES ON REFERENCE NUMBERS IN THE FIGURES

1—feed-liquid supplying valve; 2—feed-liquid backflow valve; 3—membrane filter tank gas supplying valve; 4—biological reaction tank gas supplying valve; 5—reverse direction cleaning valve; 6—produced water valve; 7—normal direction cleaning valve; 8—biological reaction tank; 9—membrane filter tank; 10—produced water storing tank; 11—feed-liquid supplying pipe; 12—feed-liquid backflow pipe; 13—anoxic zone; 14—oxic zone; 15—circulating pump; 16—outflow pump; 17—cleaning pump; 18—agent loading pump; 19—membrane separation device; 20—permeated liquid outlet; 21—agent storing device; 22—blower; 23—gas distribution device inside the membrane filter tank; 24—gas distribution device inside the biological reaction tank; 25—water distribution device; 26—pressure gauge; 27—flow meter; 28—partition wall.

### DESCRIPTION OF THE PREFERRED EMBODIMENTS

The above technical solutions and other related technical details will be explained and described in detail hereinafter.

A wastewater treatment equipment comprises a biological reaction tank and a membrane separation device provided outside the biological reaction tank, wherein a mixing device is provided inside the biological reaction tank, and an aeration device is provided inside the membrane separation device or inside a container for accommodating the membrane separation device, the biological reaction tank is connected to the membrane separation device or the container for accommodating the membrane separation device through a pipeline.

One or more filter units are provided in the membrane separation device. The filter unit indicates an module having filtering function, which could be various filter units available in the field of water treatment, such as a hollow fiber bundle type membrane module, a hollow fiber curtain type membrane module, a plate and frame type membrane module, a capillary type membrane module, a tube type membrane module and microporous filter pipe, etc.

The membrane separation device may have or not have an enclosed housing. When the membrane separation device has an enclosed housing, the housing should have a feed-liquid inlet and a feed-liquid outlet for conveying the liquid to be filtered, which inlet and outlet are connected to the biological reaction tank through a pipeline. When the membrane separation device does not have an enclosed housing, a surface of the filter unit that contacts with the liquid to be treated is exposed. At this time, the membrane separation device may be placed in a box or a small construction (i.e., the so-called membrane filter tank) which is provided independent of the biological reaction tank and has a volume slightly larger than the membrane separation device itself, unlike the membrane separation device in an internal MBR which is placed in a biological reaction tank whose volume is much bigger than the membrane separation device itself. Thus, it is very convenient to directly perform on-line chemical agent soaking cleaning on the membrane separation device in the membrane filter tank so as to thoroughly recover the filtering performance of filter unit of the membrane separation device. Depending on specific requirements of engineering design, the membrane filter tank can share a wall with the biological reaction tank, or can be provided separate from the biological reaction tank.

Depending on the growth type of microorganism in the biological reaction tank, the biological reaction tank can be a suspended growth type active sludge reactor, or an attached growth type biofilm reactor, or a composite reactor with a suspended growth type active sludge and an attached growth type biofilm. Preferably, the biological reaction tank is a suspended growth type active sludge reactor. According to the flow state of material in the reactor, the biological reaction tank can be a plug flow reactor, or a completely mixed reactor, or a reactor which, like an oxidation ditch, has both a plug flow pattern and a completely mixed flow pattern. According the material feeding manner of reactor, the biological reaction tank can be an intermittent type, a half-intermittent type, or a continuous type.

Since a hydraulic shear force formed when a gas/water two-phase flow cross flows on the surface of filter unit can effectively inhibit deposition of pollutants on the surface of filter unit, an aeration device is provided inside the membrane separation device or inside the membrane filter tank for accommodating the membrane separation device, and the aeration device is used to perform continuous aeration in the membrane separation device or the membrane filter tank so as to provide a dissolved oxygen and a cross flow velocity simultaneously. Since the inhibition of deposition of pollutants on the surface of filter unit has a demand on the minimum value of cross flow velocity, providing the minimum cross flow velocity also has a demand on the minimum value of aeration intensity in the membrane filter tank. The aeration intensity means the aeration amount of the membrane separation device on unit area and in unit time, in a cross section perpendicular to the liquid flowing direction of the two-phase flow of gas and water. Even if membrane separation device has a high space utilization rate, i.e., the cross section perpendicular to the liquid flowing direction of the two-phase flow of gas and water is small, the overall aeration amount calculated based on the minimum cross flow velocity is also large, whereby the mixed liquor inside the membrane separation device or the membrane filter tank is generally in a stable highly dissolved state, and the dissolved oxygen (DO) concentration is generally 3-4 mg/L or even larger.

The biological reaction tank is connected to the membrane separation device or the membrane filter tank through a pipeline to realize a circulating flow of mixed liquor therebetween. There are generally two pipelines for connection, one of which is referred to as feed-liquid supply pipe, and the other of which is referred to feed-liquid backflow pipe hereinafter. The feed-liquid supply pipe is used to direct the mixed liquor inside the biological reaction tank to the membrane separation device or the membrane filter tank, while the feed-liquid backflow pipe is used to backflow concentrate inside the membrane separation device or the membrane filter tank to the biological reaction tank. The backflow concentrate sufficiently mixes with the mixed liquor inside the biological reaction tank under the action of the mixing device provided inside the biological reaction tank, so that the massive dissolved oxygen carried by the concentrate flowing back from the membrane separation device or the membrane filter tank furthest complements the biological reaction tank and the aeration amount of the biological reaction tank is reduced. By comparison, the prior art negative pressure external MBR can only realize an incomplete mix of concentrate flowing back from the membrane separation device or the membrane filter tank with partial mixed liquor inside the biological reaction tank, thus resulting in a waste of energy consumption of high intensity aeration inside the membrane separation device or the membrane filter tank. Therefore, the invention can, on the whole, further reduce the gas/water ratio of MBR so that the operational energy consumption is maintained at the relatively low level.

The mixing device can use three types of devices in the field of water treatment, i.e., a water distribution device, an agitating device and a mechanical aeration device. The water distribution device can be a branch or annular shape water distribution pipe network composed of perforated pipes, or various other dedicated water distributors. The agitating device can be a submersible agitating machine installed below the liquid surface, or a vertical stirrer with its shaft installed vertically, or various other agitating devices. The mechanical aeration device can be a surface aerator with its shaft installed horizontally, such as a rotating brush aerator, or a rotating disc aerator, etc, or a vertical surface aerator with its shaft installed vertically, or various underwater aeration devices such as a submersible aerator.

Since the tank volume of a biological reaction tank is generally designed according to HRT, and the volume of a membrane separation device or the tank volume of a membrane filter tank is far less than the tank volume of a biological reaction tank (generally, being ⅓- 1/10 of latter). The dissolved oxygen concentration of concentrate flowing back from the membrane separation device or the membrane filter tank is generally 2-4 mg/L, and concentrate, after sufficiently mixing with the mixed liquor inside the biological reaction tank, can provide the biological reaction tank with a dissolved oxygen concentration which is generally as high as 0.2-1.0 mg/L. Even if taking into consideration the fact that there may be some loss of dissolve oxygen during transmission of concentrate flowing back from the membrane separation device or the membrane filter tank, the dissolved oxygen concentration that can be brought to the biological reaction tank can generally reach 0.1-0.5 mg/L, which concentration is just a dissolved oxygen state required for denitrobacteria to implement the denitrification process. Therefore, the wastewater treatment process and equipment according to the invention can be applied to wastewater treatment applications where denitrification process is required.

Considering that heterotrophic microorganism oxidizes carbonaceous organism aerobic biology, DO concentration in the biological reaction tank is preferably 3-4 mg/L and should not be lower than 2 mg/L, while a nitrification of the nitrifiers also demands that DO concentration in the biological reaction tank should not be lower than 2 mg/L. In order to reach the requirement for a relatively high concentration of dissolved oxygen required by carbon oxidation and nitrification, an aeration device can be additionally provided in the biological reaction tank, or a set of aeration devices can simultaneously provide oxygen for the membrane separation device and the biological reaction tank.

Since concentrate flowing back from the membrane separation device or the biological reaction tank having a relatively small volume is enough to keep an anoxic environment required by the denitrification process in the biological reaction tank, a phased design or a sectional design may be applied to the distribution of dissolved oxygen in the biological reaction tank. The phased design means that the dissolved oxygen varies in time sequence, and the sectional design means that the dissolved oxygen varies in space, both of which can create a dissolved oxygen environment in which anoxic-aerobic, or even anoxic-anaerobic-aerobic states alternatively circulate. The dissolved oxygen environment in which anoxic-aerobic states alternatively circulate can create appropriate conditions for biological denitrification, while the dissolved oxygen environment in which anoxic-anaerobic-aerobic states alternatively circulate can create appropriate conditions for synchronized biological denitrification and dephosphorization.

When the biological reaction tank is continuously provided with additional oxygen by the aeration device, the mixed liquor inside the biological reaction tank is generally in a continuous aerobic state, so that the aerobic biological oxidation of organism and the nitrification are mainly taking place inside the biological reaction tank, and organisms and ammonia nitrogen in the raw wastewater can be removed effectively.

When the biological reaction tank is intermittently provided with additional oxygen by the aeration device, the mixed liquor inside the biological reaction tank is generally in an aerobic-anoxic alternative circulation state, so that the aerobic biological oxidation of organism, the nitrification and the denitrification are mainly taking place inside the biological reaction tank. Therefore, not only organisms and ammonia nitrogen in the raw wastewater can be removed, but also the total nitrogen in the raw wastewater can be removed effectively.

When the effective water depth of the biological reaction tank is relatively deep, the mixing device can employ a water distribution device that is a branch or annular shape water distribution pipe network composed of perforated pipes, and the water distribution device is disposed at the bottom of the biological reaction tank. The aeration device only provides the upper portion of the biological reaction tank with oxygen continuously, and the water depth of the area that is provided with oxygen is no smaller than ½ of the effective water depth of the biological reaction tank. Therefore, there are two longitudinal divisional areas in the longitudinal direction from tank bottom to liquid surface inside the biological reaction tank, i.e., an anoxic zone and an oxic zone, and the volume ration between the oxic zone and the anoxic zone is no smaller than 1. Thus, the nitrification and the denitrification can simultaneously take place in the biological reaction tank, and organism, ammonia nitrogen and total nitrogen in the raw wastewater can be removed effectively. When the biological reaction tank has a larger effective water depth, there can be three longitudinal divisional areas in the longitudinal direction from tank bottom to liquid surface inside the biological reaction tank, i.e., an anoxic zone, an anaerobic zone and an oxic zone, so that in addition to co-current nitrification and denitrification, an anaerobic phosphorus releasing process and an aerobic phosphorus absorbing process of phosphate accumulating organisms (PAOs) are simultaneously taking place inside the biological reaction tank. Therefore, not only organism, ammonia nitrogen and total nitrogen in the raw wastewater can be removed effectively, but also the total phosphorus in raw wastewater can be removed by excluding phosphorus-rich sludge inside the oxic zone or inside the membrane filter tank.

When the effective water depth of the biological reaction tank is relatively shallow, the mixing device can employ a water distribution device that is a branch or annular shape water distribution pipe network composed of perforated pipe, or employ an agitating device or a mechanical aeration device. Meanwhile, a partition wall is provided inside the biological reaction tank to divide the interior of the biological reaction tank into two portions sequentially from the upstream to the downstream of water flow, i.e., the anoxic zone and the aerobic zone. The mixing device is located in the anoxic zone and the aeration device provides oxygen only for the oxic zone. The mixed liquor in the anoxic zone can fall into the oxic zone over a top portion of the partition wall, or enter the oxic zone through guide holes provided on the partition wall, and mixes with mixed liquor inside the oxic zone. Mixed liquor containing nitrate in the oxic zone flows back to the anoxic zone via the membrane separation device or the membrane filter tank. In this way, the anoxic zone, as a front denitrification section, accomplishes the removal of total nitrogen mainly by an denitrification, the oxic zone accomplished the removal of organism and ammonia nitrogen by an aerobic biological oxidation of organism and nitrification, and the whole device can remove organism, ammonia nitrogen and total nitrogen in raw wastewater effectively. It is also possible to provide two partition walls in the biological reaction tank, which divides the interior of the biological reaction tank into three portions sequentially from the upstream to the downstream of water flow, i.e., the anoxic zone, the anaerobic zone and the oxic zone. The mixing device is located in the anoxic zone and the aeration device provides oxygen only for the oxic zone. The mixed liquor in the anoxic zone can fall into the anaerobic zone over a top portion of the first partition wall, or enter the anaerobic zone through guide holes provided on the first partition wall, and mixes with mixed liquor inside the anaerobic zone. Also, mixed liquor in the anaerobic zone can fall into the oxic zone over a top portion of the second partition wall, or enter the oxic zone through guide holes provided on the second partition wall, and mixes with mixed liquor inside the oxic zone. Mixed liquor containing nitrate in the oxic zone flows back to the anoxic zone via the membrane separation device or the membrane filter tank. In this way, the whole biological reaction tank is an inverted A²/O system, wherein the anoxic zone mainly removes total nitrogen by an denitrification, the anaerobic zone accomplishes phosphorus releasing process of phosphate accumulating organisms, and the oxic zone mainly removes organism and ammonia nitrogen by an aerobic biological oxidation of organism and nitrification, and accomplishes aerobic phosphorus absorbing process of phosphate accumulating organisms. The total phosphorus in raw wastewater can be removed by excluding phosphorus-rich sludge inside the oxic zone or inside the membrane filter tank, and the whole device can remove organism, ammonia nitrogen, total nitrogen and total phosphorus in raw wastewater effectively.

In order to better achieve a circulating flow of mixed liquor between the biological reaction tank and the membrane separation device or the membrane filter tank, a circulating pump can be installed in the pipeline. The circulating pump can be installed in the feed-liquid supply pipe, or in the feed-liquid backflow pipe. When the circulating pump is installed in the feed-liquid supply pipe, the liquid level of the membrane separation device or the membrane filter tank should be higher than the liquid level of the biological reaction tank, so that concentrate inside the membrane separation device or the membrane filter tank can flow to the biological reaction tank by itself under the action of gravity, and the mixed liquor inside the biological reaction tank, after being pressurized by the circulating pump, enters the membrane separation device or the membrane filter tank. When the circulating pump is installed in the feed-liquid backflow pipe, the liquid level of the membrane separation device or the membrane filter tank should be lower than the liquid level of the biological reaction tank, so that mixed liquor inside the biological reaction tank can flow to the membrane separation device or the membrane filter tank by itself under the action of gravity, and the concentrate inside the membrane separation device or the membrane filter tank, after being pressurized by the circulating pump, enters the biological reaction tank. Preferably, the circulating pump is installed in the feed-liquid backflow pipe. In this way, when an on-line agent soaking cleaning is required to be performed on the membrane separation device, the circulating pump can be directly utilized to rapidly discharge concentrate inside the membrane separation device or the membrane filter tank into the biological reaction tank, thus not only avoiding loss of active microorganism, but also shortening the time required for completing cleaning, which is of particular importance for large-scale wastewater treatment projects.

When the membrane separation device is placed inside the membrane filter tank, the feed-liquid supply pipe can be connected to the upper portion of the lower portion of the membrane filter tank. When the feed-liquid supply pipe is connected to the upper portion of the membrane filter tank, the feed-liquid backflow pipe is connected to the lower portion of the membrane filter tank. At this time, the mixed liquor inside the membrane filter tank flows down. When the feed-liquid supply pipe is connected to the lower portion of the membrane filter tank, the feed-liquid backflow pipe is connected to the membrane filter tank through two branch pipelines, one of which is connected to the membrane filter tank at an upper portion of the membrane filter tank, and the other of which is connected to the membrane filter tank at a lower portion of the membrane filter tank. Both the branch pipelines are provided with valves so as to realize mutual switch. During normal operation, mixed liquor inside the membrane filter tank is an upward flow, and the valve in the branch pipeline connected to the lower portion of the membrane filter tank is in a closed state.

The membrane separation device can discharge treated water by itself using a liquid level difference between a liquid surface inside the membrane separation device or a liquid surface inside the membrane filter tank and a permeated liquid outlet, or pump treated water by an effect of negative pressure provided by an outflow pump connected to the permeated liquid outlet. Preferably, the membrane separation device pumps treated water by an effect of negative pressure provided by an outflow pump connected to the permeated liquid outlet. In this way, when the liquid surface of a produced water storing tank for storing the final treated water of the system is higher than that of the biological reaction tank, or lower than the liquid surface of the biological reaction tank by an amount that is not enough to make the permeated liquid discharge, an outflow pump can make the produced water flow of the membrane separation device more stable. More preferably, the pipeline connecting the permeated liquid outlet of the membrane separation device to the produced water storing tank is divided into two branch pipelines, one of which is connected to a water inlet of the outflow pump, a water outlet of which is connected to the produced water storing tank through a pipeline, and the other of which is directly connected to the produced water storing tank. Thus, these two branch pipelines are in parallel and can be used for replacement of each other by means of a control of valves.

The aeration device providing oxygen for the membrane separation device or the membrane filter tank can be a blowing aeration system composed of a blower and a gas distribution device, or a mechanical aeration device such as a jet submersible aerator, etc. Preferably, the aeration device providing oxygen for the membrane separation device or the membrane filter tank is a blowing aeration system composed of a blower and a gas distribution device. The aeration device inside the biological reaction tank can be a blowing aeration system composed of a blower and a gas distribution device, or various mechanical aeration devices such as a submersible aerator and a surface aerator.

The cross-section of the biological reaction tank or the membrane filter tank which is parallel with a horizontal plane can be a rectangle, or a circle, an ellipse or any other shape.

A pre-treatment device can be provided at the front section of the wastewater treatment equipment, which is composed any one or more than two of the following: bar screen, strainer, hair collector, grit chamber, primary settling tank, equalization tank, grease/oil interceptor, PH adjusting device, ion exchange device, adsorption device, coagulation sedimentation device, floatation device, anaerobic reaction device (including but not limited to hydrolysis acidification, upflow anaerobic sludge bed, expanded granular sludge bed, inter circulation reactor, etc), advanced oxidation device (including but not limited to normal temperature catalytic oxidation, high temperature catalytic oxidation, photo catalytic oxidation, high temperature wet oxidation), electrolytic device, microwave device. The pre-treatment device is used to remove big blocks of floating objects, suspended objects, long fibrous objects, mud and sands, grease and oil, heavy metals that are harmful to microorganism, and organic pollutants whose microorganism is hard to degrade, so that the temperature of water after being pre-treatment is kept between 10-40□, pH value is kept between 6-9, the ratio between five day Biochemical Oxygen Demand (BOD5) and Chemical Oxygen Demand (COD) is kept above 0.3. The pre-treated wastewater enters the biological reaction tank.

A post-treatment device can be provided at the rear section of the wastewater treatment device, which is composed any one or more than two of the following: chlorinating disinfection device (the disinfectant including but not limited to chlorine gas, sodium hypochlorite, chlorine dioxide, etc.), ultraviolet disinfection device, ozone device, ion exchange device, adsorption device, coagulation sedimentation device, flocculating filtration device, activated carbon device (the activated carbon being particulate shape or powder shape), ultrafiltration membrane, nanofiltration membrane, reverse osmosis membrane. The post-treatment device is used to further disinfect and decolorize produced water obtained by membrane separation, or further remove small-molecule organism and inorganic salt still remaining in the produced water. The post-treated produced water enters the produced water storing tank.

Preferably, a pre-treatment device and a post-treatment device can be simultaneously provided in the front section and the rear section of the wastewater treatment device respectively.

The aeration device may operate continuously, or intermittently. When the aeration device operates continuously, the frequency or output gas amount of the aeration device can be dynamically adjusted by real-time monitoring the DO concentration or oxidation-reduction potential (ORP) inside the biological reaction tank or the membrane filter tank, so that energy consumption can be further saved.

The principle and variation of the wastewater treatment device according to the invention described above is also applicable to a wastewater treatment process provided by the invention. That is, the wastewater treatment process and wastewater treatment device according to the invention are supplementary to each other. The cooperative uses thereof complement with each other, and can achieve a better wastewater treatment effect.

The technical solution of the invention will be further described in detail in connection with the accompanying drawings and embodiments.

### The First Embodiment

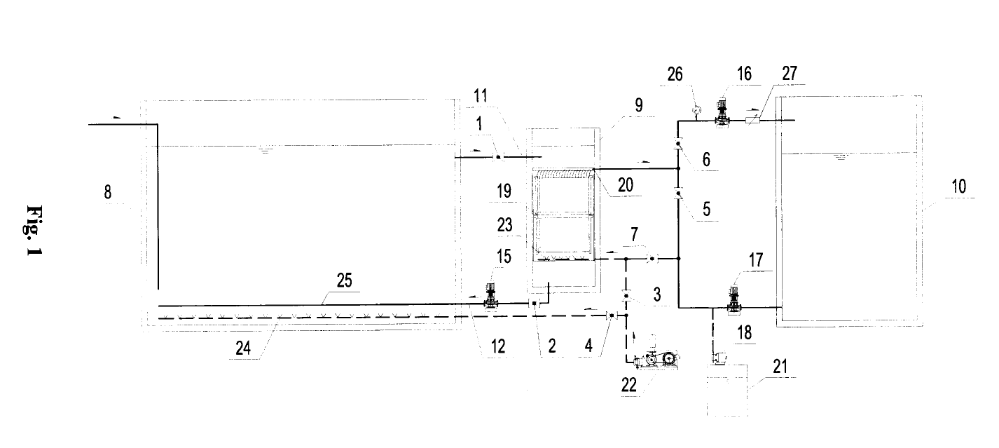

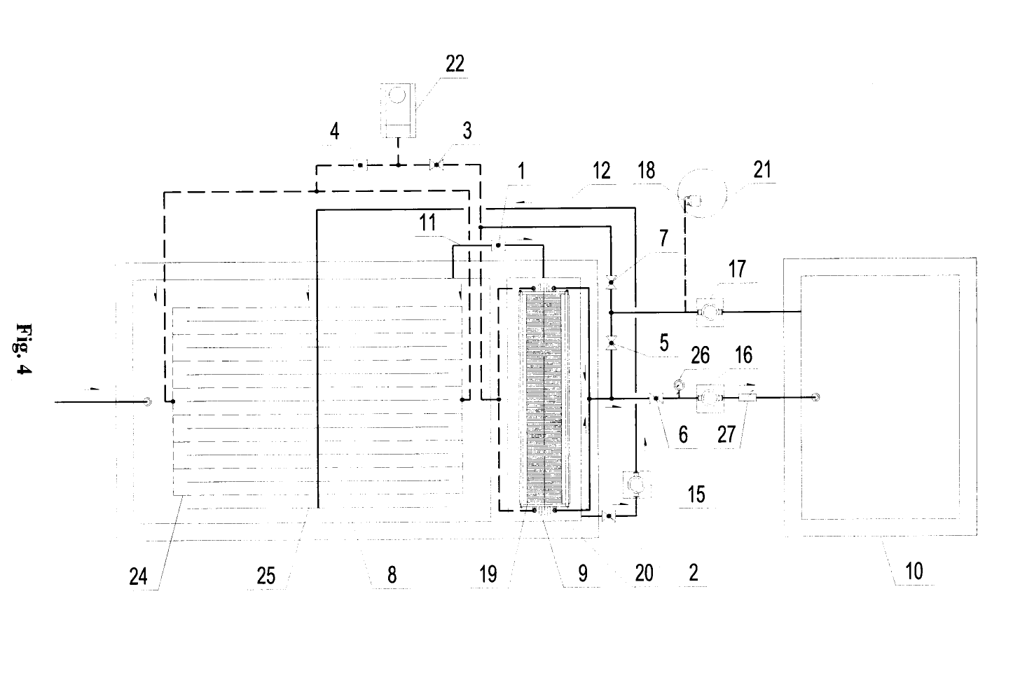

As shown in FIGS. 1 and 4, a wastewater treatment device comprises a biological reaction tank 8; a membrane filter tank 9 which is provided independent from the biological reaction tank 8 and shares a wall with the biological reaction tank 8; a membrane separation device 19 installed inside the membrane filter tank; a produced water storing tank 10 for storing liquid permeating the membrane separation device, a feed-liquid supply pipe 11 and a feed-liquid supply valve 1 installed thereon, the feed-liquid supply pipe 11 being used to convey activated sludge mixed liquor inside the biological reaction tank 8 to the membrane filter tank 9, wherein the feed-liquid supply pipe 11 penetrates the side wall of the biological reaction tank 8 at an upper portion of the side wall thereof, while the top of the pipe is lower than water level inside the biological reaction tank 8 by 400 mm, and the feed-liquid supply pipe 11 penetrates the side wall of the membrane filter tank 9 at an upper portion of the side wall thereof, while the top of the pipe is lower than the water level inside the membrane filter tank 9 by 200 mm, and the position is located above the membrane separation device 19; a feed-liquid backflow pipe 12 for conveying concentrate in the membrane filter tank 9 back to the biological reaction tank 8; a circulating pump 15 installed in the feed-liquid backflow pipe 12, wherein a pipeline connected to a water inlet of the circulating pump 15 is in communication with the bottom of the membrane filter tank 9 and located below the membrane separation device 19; a feed-liquid backflow valve 2 installed in the pipeline connected to the water inlet of the circulating pump 15; a water distribution device 15 installed at the bottom of the biological reaction tank 8 and composed of perforated pipes which is connected to a water outlet of the circulating pump 15 through the feed-liquid backflow pipe 12; an outflow pump 16 providing negative pressure for the membrane separation device 19, a water inlet of the pump 16 being connected to a permeated liquid outlet 20 of the membrane separation device 19 through a pipeline provided with a produced water valve 6, and a water outlet of the pump 16 being connected to the produced water storing tank 10 through a pipeline in which a pressure gauge 26 and a flow meter 27 are installed; a blower 22 serving as gas source, a pipeline connected to gas outlet of the blower 22 being divided into two branch pipelines, one of which is connected to a gas distribution device 23 installed inside the membrane filter tank 9 and is provided a membrane filter tank gas supply valve 3 thereon, and the other of which is connected to a gas distribution device 24 installed inside the biological reaction tank 8 and is provided a biological reaction tank gas supply valve 4 thereon; a cleaning pump 17, a water inlet of the pump 17 being connected to the produced water storing tank 10 through a pipeline, and a pipeline connected to a water outlet of the pump 17 being divided into two branch pipelines, one of which is connected to the pipeline connecting the permeated liquid outlet 20 with the water inlet of the outflow pump 16 and is provided with a reverse direction cleaning valve 5 thereon, and the other of which is connected to the pipeline connecting the blower 22 with the gas distribution device 23 inside the membrane filter tank 9 and is provided a normal direction cleaning valve 7 thereon; an agent loading pump 18 is installed right above a cylinder shaped agent storing device 21 which is installed adjacent to the produced water storing tank 10, a pipeline connected to the outlet of the agent loading pump 18 being connected to a pipeline at the water outlet of the cleaning pump 17, a junction is located at a manifold pipe on the upstream of the reverse direction cleaning valve 5 and the normal direction cleaning valve 7.

The water distribution device 25 is a branch shape water distribution pipe network composed of 16 perforated pipes distributed symmetrically on both sides of a water distribution manifold pipe. The perforated pipes are provided with water distribution apertures having a diameter of 2-20 mm. The manifold pipe is located in the middle of the biological reaction tank 8. The 8 perforated pipes on each side of the general pipe are arranged in parallel and equidistantly, and the length thereof is slightly smaller than the size of the biological reaction tank 8, so that water can be distributed all across the biological reaction tank 8 and communicate with each other, and concentrate which has backflowed from the membrane filter tank 9 enters the 16 perforated pipes respectively and flows out from the water distribution apertures.

The membrane separation device 19 is composed of hollow fiber curtain type membrane module filter units. 16 membrane separation devices are arranged in two rows with 8 devices in each row. The outer size of each of the membrane separation devices 19 is 600 mm(length)×600 mm(width)×1800 mm(height). There are 10 pieces of hollow fiber curtain type membrane modules integrated in the membrane separation device 19, with each piece of hollow fiber curtain type membrane module composed of 398 hollow fibrous membrane fibers. The outer diameter of the hollow fibers is 2.8 mm, the average membrane pore diameter is 0.4 μm, the material thereof is polyvinylidene fluoride. The upper ends of the fibers can swing freely, each of which is in the closed state and is sealed using a flexible epoxy resin. The lower ends of the fibers are collected in an end portion using epoxy resin casting, and are secondarily cast using polyurethane so as to protect the root portion of fiber. The end portion is externally provided with a produced water pipe which has a diameter of 8 mm. All the produced water pipes are connected in parallel to a collector manifold pipe.

The net sizes inside the biological reaction tank 8 are 5 m(height)×6.5 m(length)×3.5 m(depth), the effective water depth is 3 m, and the effective volume is 97.5 m³. The net sizes inside the membrane filter tank 9 are 5 m(height)×1.5 m(length)×3.5 m(depth), the effective water depth is 2.8 m, and the effective volume is 21 m³. The net sizes inside the produced water storing tank 10 are 5 m(height)×3 m(length)×3.5 m(depth), the effective water depth is 3 m, and the effective volume is 45 m³.

The flow rate of the circulating pump 15 is 120 m³/h, the pump lift thereof is 11 m, and the power thereof is 5.5 kW. The flow rate of the outflow pump 16 is 25 m³/h, the pump lift thereof is 10 m, and the power thereof is 1.1 kW. The flow rate of the cleaning pump 17 is 80 m³/h, the pump lift thereof is 15 m, and the power thereof is 5.5 kW. The flow rate of the agent loading pump 18 is 1.5 m³/h, the pump lift thereof is 8 m, and the power thereof is 90 W. The wind rate of the blower 22 is 3.86 m³/min, wind pressure thereof is 39.2 kPa, and the power thereof is 5.5 kW. The outer size of the agent storing device 21 is Φ1000 mm×1500 mm, and the effective volume is 1000 L.

The inner diameters of the feed-liquid supply pipe 11 and the feed-liquid backflow pipe 12 are both 200 mm. All of the feed-liquid supply valve 1, feed-liquid backflow valve 2, the membrane filter tank gas supply valve 3, the biological reaction tank gas supply valve 4, the reversion cleaning valve 5, the produced water valve 6 and the normal direction cleaning valve 7 are motorized valves.

When the raw water is common domestic wastewater, main indexes of water quality are as follows: pH=6-9, COD_{Cr}=400-500 mg/L, BOD₅=100-300 mg/L, SS=100-300 mg/L, ammonia nitrogen=20-60 mg/L, TN=20-80 mg/L. A rotary mechanical grating with a discharge capacity of 30 m³/h and a grid gap of 2 mm, an equalization tank with an effective volume of 200 m³, and a hair collector with a discharge capacity of 30 m³/h can be used as the pre-treatment device provided at the front section of the wastewater treatment device of the invention.

For the type described above of wastewater, the wastewater treatment device of the invention can reach a treatment capacity of 20.8 m³/h and a treatment scale of 500 m³/day. The hydraulic retention time of the biological reaction tank 8 is about 4.7 hours, mixed liquor suspended solids (MLSS) thereof is 5-8 g/L, volume load thereof is 1.0-1.5 kg-BOD₅/(m³·d), sludge load thereof is 0.13-0.21 kg-BOD₅/(kg-MLSS·d). The hydraulic retention time of the membrane filter tank 9 is about 1 h, the overall hydraulic retention time of the biological reaction tank 8 and the membrane filter tank 9 is about 5.7 h, and the hydraulic retention time of the produced water storing tank 10 is about 2.2 h.

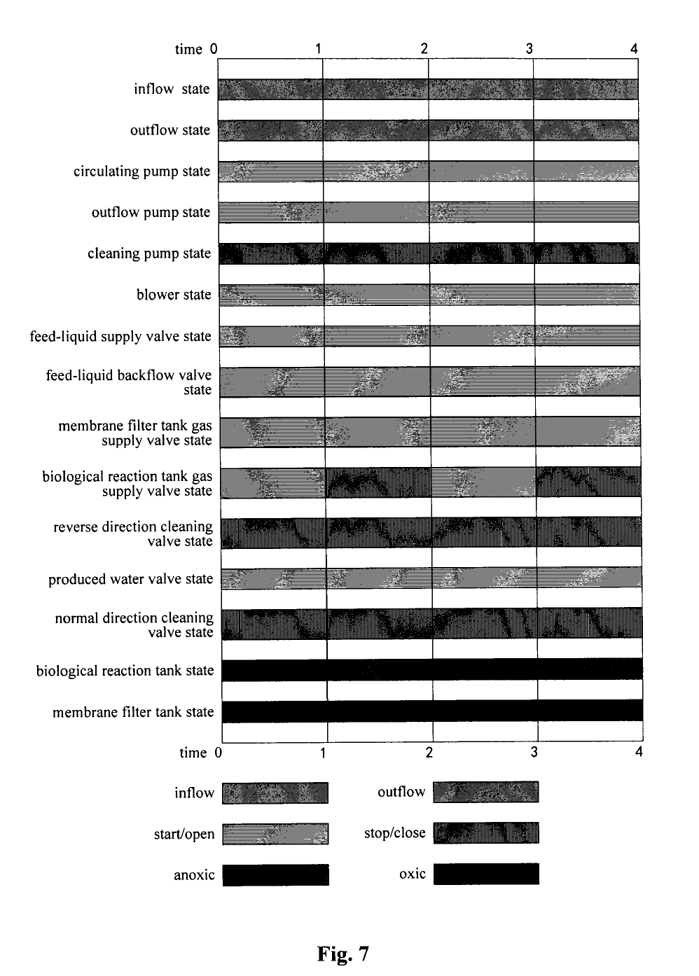

As shown in FIG. 7, when the wastewater treatment device of the invention is operating, the system charges and discharges water continuously, and the biological reaction tank 8 is always in an aerobic state, the aeration amount is 58.8 m³/h, the ratio of gas to water is 2.8:1; the aeration amount inside the membrane filter tank 9 is 172.8 m³/h, the ratio of gas to water is 8.3/1; and the overall aeration amount of the biological reaction tank 8 and the membrane filter tank 9 is 231.6 m³/h, the overall ratio of gas to water is 11.1:1.

Wastewater first enter the lower portion of the biological reaction tank 8, and sufficiently contacts activated sludge mixed liquor under the effect of turbulent flow provided by the gas distribution device 24 and water distribution device 25. The aerobic heterotrophic bacteria will perform biological degradation of organic substrate, and nitrobacteria will convert ammonia nitrogen in the wastewater into nitrate nitrogen. Then, activated sludge mixed liquor inside the biological reaction tank 8 enters the membrane filter tank 9 from the upper portion thereof via the feed-liquid supply pipe 11. A solid/liquid separation of activated sludge mixed liquor inside the membrane filter tank 9 can be realized thoroughly due to highly efficient separation of the membrane separation device 19. Produced water formed by permeating membrane gradually converges to permeated liquid outlet 20, then conveyed to the produced water storing tank 10 by the outflow pump 16. Compressed air provided by the blower 22 diffuses out through a gas distribution device 23 inside the membrane filter tank 9, and directly washes the root portion of the hollow fiber membrane bundle, so as to effectively prevent sludge gathering at the root portion of the membrane bundle and inhibit the development of membrane fouling at an appropriate level. Concentrate inside the membrane filter tank 9, after pressurized by the circulating pump 15, finally enters the water distribution device 25 installed at the bottom of the biological reaction tank 8 via the feed-liquid backflow pipe 12, and diffuses out through water distribution apertures of the water distribution device 25 to re-mix with activated sludge mixed liquor inside the biological reaction tank 8. Meanwhile, oxygen-enriched water formed by high intensity aeration inside the membrane filter tank 9 is brought back to the biological reaction tank 8, thus avoiding the problem of dissolved oxygen loss caused when concentrate flows directly to the biological reaction tank 8 from the top of the membrane filter tank 9.

After being treated by the wastewater treatment device of the invention, main indexes of produced water are as follows: COD_{Cr}=20-30 mg/L, BOD₅=1-5 mg/L, SS=0 mg/L, ammonia nitrogen=0.1-1 mg/L, and the removal rates are respectively as follows: COD_{Cr}≧94%, BOD₅≧96%, SS=100%, ammonia nitrogen≧98%.

### The Second Embodiment

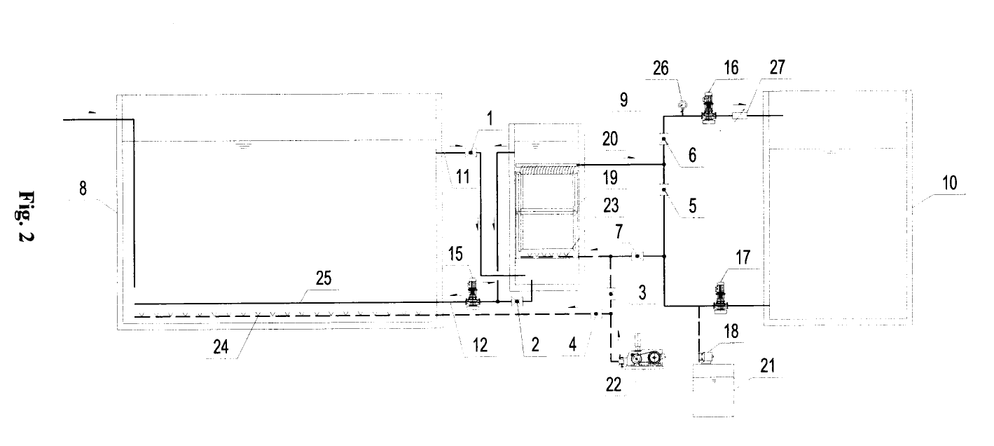

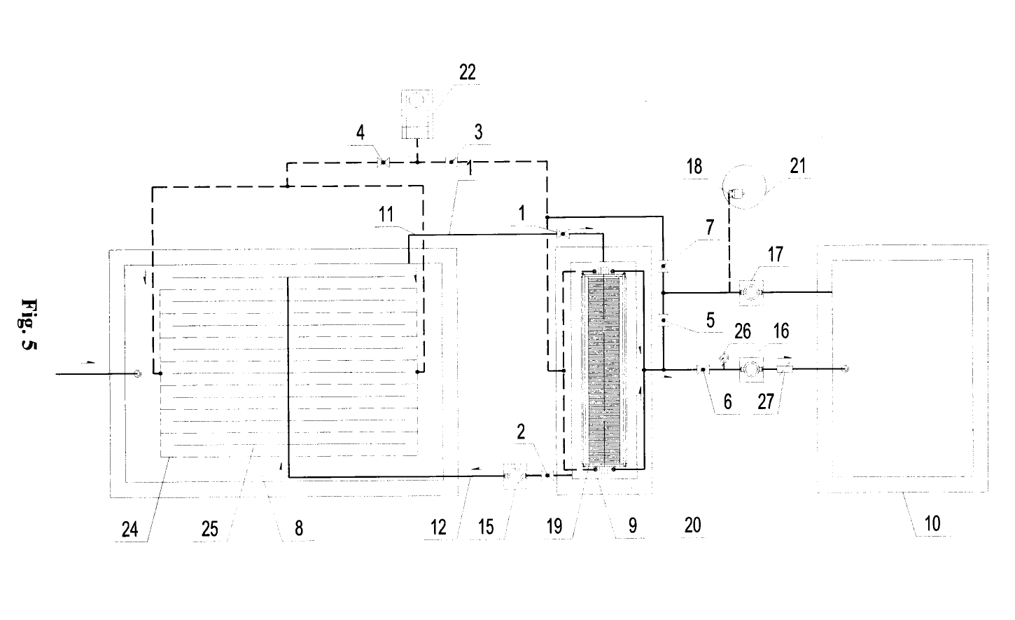

As shown in FIGS. 2 and 5, a wastewater treatment device is provided, most structures of which are the same as the first embodiment, except that the feed-liquid supply pipe 11 for conveying activated sludge mixed liquor inside the biological reaction tank 8 to the membrane filter tank 9 penetrates the side wall of the biological reaction tank 8 at an upper portion of the side wall thereof, while the top of pipe is lower than water level inside the biological reaction tank 8 by 400 mm, and the feed-liquid supply pipe 11 penetrates the side wall of the membrane filter tank 9 at a lower portion of the side wall thereof, while the bottom of the pipe is higher than the bottom of the membrane filter tank 9 by 100 mm, and the position is located below the membrane separation device 19; and the feed-liquid backflow pipe 12 for conveying concentrate in the membrane filter tank 9 back to the biological reaction tank 8 is divided into the two branches, one of which penetrates the side wall of the membrane filter tank 9 at an upper portion of the side wall thereof while the top of the pipe is lower than the water level inside the membrane filter tank 9 by 200 mm, the other of which penetrates the side wall of the membrane filter tank 9 at a lower portion of the side wall thereof while the bottom of the pipe is higher than the bottom of the membrane filter tank 9 by 100 mm, and the position is located below the membrane separation device 19, wherein the feed-liquid backflow valve 2 is installed in the other branch, the circulating pump 15 is installed in a manifold pipe with the two converged branches, and the water distribution device 25 installed at the bottom of the biological reaction tank 8 is connected to water outlet of the circulating pump 15. The membrane separation device 19 is composed of hollow fiber bundle type membrane module filter units. 16 membrane separation devices are arranged in two rows with 8 devices in each row. The outer size of each of the membrane separation device 19 is 500 mm(length)×500 mm(width)×1800 mm(height). There are 25 bundles of hollow fiber bundle type membrane modules integrated in the membrane separation device 19, with each bundle of hollow fiber bundle type membrane module composed of 300 hollow fibers. The outer diameter of the hollow fibers is 1.35 mm, the average membrane pore diameter is 0.1 μm, the material thereof is polyvinylidene fluoride. The upper ends of the fibers can swing freely, each of which is in a closed state and is sealed using a flexible epoxy resin. The lower ends of the fibers are collected in an end portion using epoxy resin casting, and are secondarily cast using polyurethane so as to protect the root portion of fiber. The end portion is externally provided with a produced water pipe which has a diameter of 8 mm. All the produced water pipes are connected in parallel to a collector manifold pipe. The wind rate of the blower 22 is 3.25 m³/min, wind pressure thereof is 39.2 kPa, and the power thereof is 4 kW

When the raw water is common domestic wastewater, main indexes of water quality are as follows: pH=6-9, COD_{Cr}=400-500 mg/L, BOD₅=200-300 mg/L, SS=100-300 mg/L, ammonia nitrogen=20-60 mg/L, TN=30-80 mg/L.

For the type described above of wastewater, the wastewater treatment device of the invention can reach a treatment capacity of 20.8 m³/h and a treatment scale of 500 m³/day. The hydraulic retention time of the biological reaction tank 8 is about 4.7 hours, mixed liquor suspended solids (MLSS) thereof is 5-8 g/L, volume load thereof is 1.0-1.5 kg-BOD₅/(m³·d), sludge load thereof is 0.13-0.21 kg-BOD₅/(kg-MLSS·d). The hydraulic retention time of the membrane filter tank 9 is about 1 h, the overall hydraulic retention time of the biological reaction tank 8 and the membrane filter tank 9 is about 5.7 h, and the hydraulic retention time of the produced water storing tank 10 is about 2.2 h.

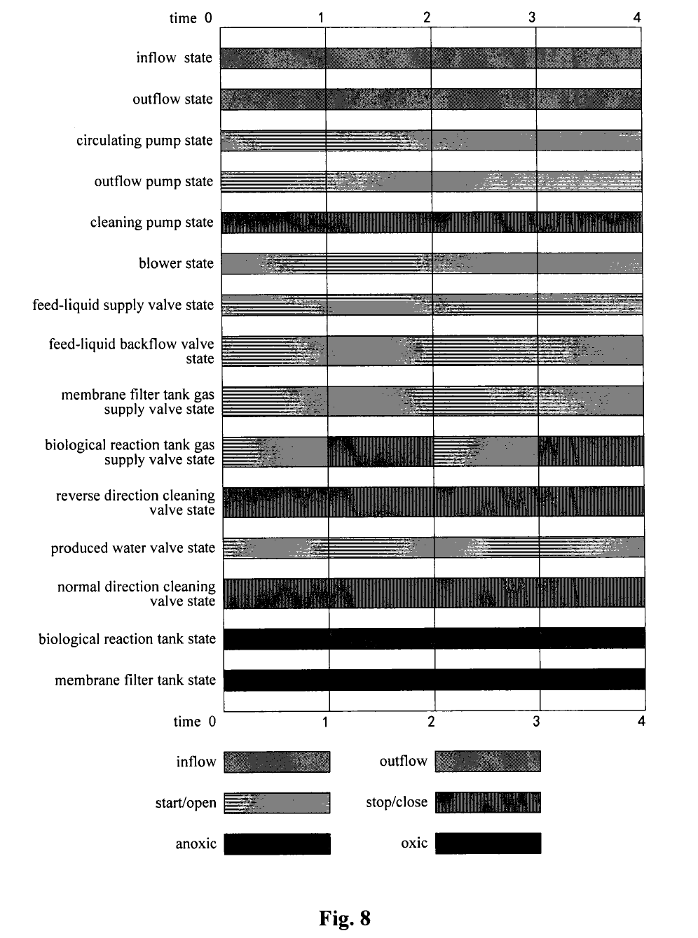

As shown in FIG. 8, when the wastewater treatment device of the invention is operating, the system charges and discharges water continuously; the biological reaction tank 8 is aerated intermittently and in the aerobic state and the anoxic state alternately. Therefore, it is an anoxic-aerobic (A/O) biologically denitrification reactor in which the anoxic state and the aerobic state alternate temporally, wherein the comprehensive aeration amount is 67.8 m³/h and the ratio of gas to water is 3.3:1. The aeration takes place continuously in the membrane filter tank 9, wherein the comprehensive aeration amount is 127.2 m³/h and the ratio of gas to water is 6.1:1. The overall aeration amount of the biological reaction tank 8 and the membrane filter tank 9 is 195 m³/h, and the overall ratio of gas to water is 9.4:1.

Wastewater first enter the lower portion of the biological reaction tank 8, and sufficiently contacts activated sludge mixed liquor under the effect of turbulent flow provided by the gas distribution device 24 and water distribution device 25. During the aerobic period, the aerobic heterotrophic bacteria will perform biological degradation of organic substrate, and nitrobacteria will convert ammonia nitrogen in the wastewater into nitrate nitrogen. During the anoxic period, denitrobacteria, by means of organic substrate, further converts nitrate nitrogen in wastewater into nitrogen gas which then escapes from water, thereby realizing removal of total nitrogen. Then, activated sludge mixed liquor inside the biological reaction tank 8 enters the membrane filter tank 9 via the feed-liquid supply pipe 11. A solid/liquid separation of activated sludge mixed liquor inside the membrane filter tank 9 can be thoroughly realized due to highly efficient separation of the membrane separation device 19. Produced water formed by permeating membrane gradually converges to permeated liquid outlet 20, then conveyed to the produced water storing tank 10 by the outflow pump 16. Compressed air provided by the blower 22 diffuses out through a gas distribution device 23 inside the membrane filter tank 9, and directly washes the root portion of the hollow fiber membrane bundle, so as to effectively prevent sludge gathering at the root portion of the membrane bundle and inhibit the development of membrane fouling at an appropriate level. Concentrate inside the membrane filter tank 9, after pressurized by the circulating pump 15, finally enters the water distribution device 25 installed at the bottom of the biological reaction tank 8 via the feed-liquid backflow pipe 12, and diffuses out through water distribution apertures of the water distribution device 25 to re-mix with activated sludge mixed liquor inside the biological reaction tank 8. Meanwhile, oxygen-enriched water formed by high intensity aeration inside the membrane filter tank 9 is brought back to the biological reaction tank 8, thus avoiding the problem of dissolved oxygen loss caused when concentrate flows directly to the biological reaction tank 8 from the top of the membrane filter tank 9. Dissolved oxygen in anoxic period of the biological reaction tank 8 is mainly provided by concentrate which has flowed back from the membrane filter tank 9. During the anoxic period, the biological reaction tank gas supply valve 4 is in a closed state, and the gas distribution device 24 no longer provides oxygen gas to the biological reaction tank 8.

After being treated by the wastewater treatment device of the invention, main indexes of produced water are as follows: COD_{Cr}=20-30 mg/L, BOD₅=1-5 mg/L, SS=0 mg/L, ammonia nitrogen=0.1-1 mg/L, TN=5-10 mg/L, and the removal rates are respectively as follows: COD_{Cr}≧94%, BOD₅≧96%, SS=100%, ammonia nitrogen≧98%, TN≧80%.

### The Third Embodiment

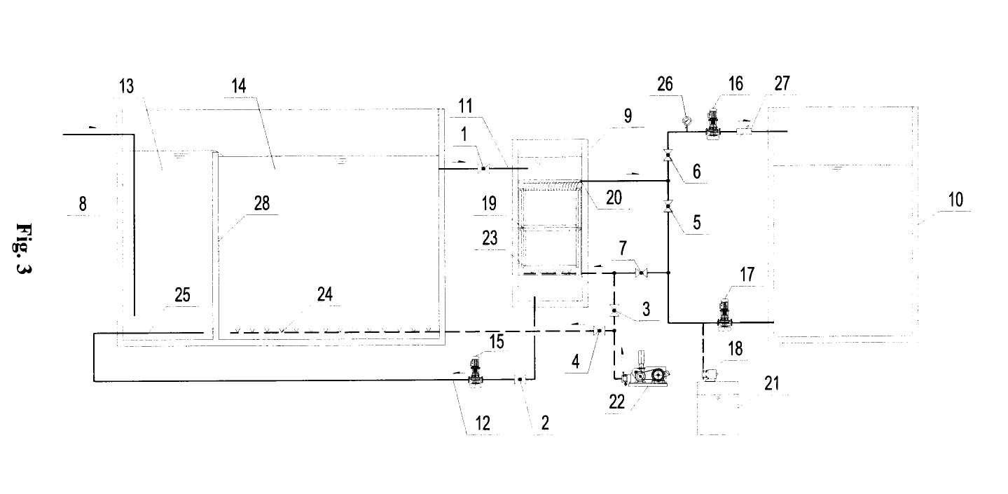

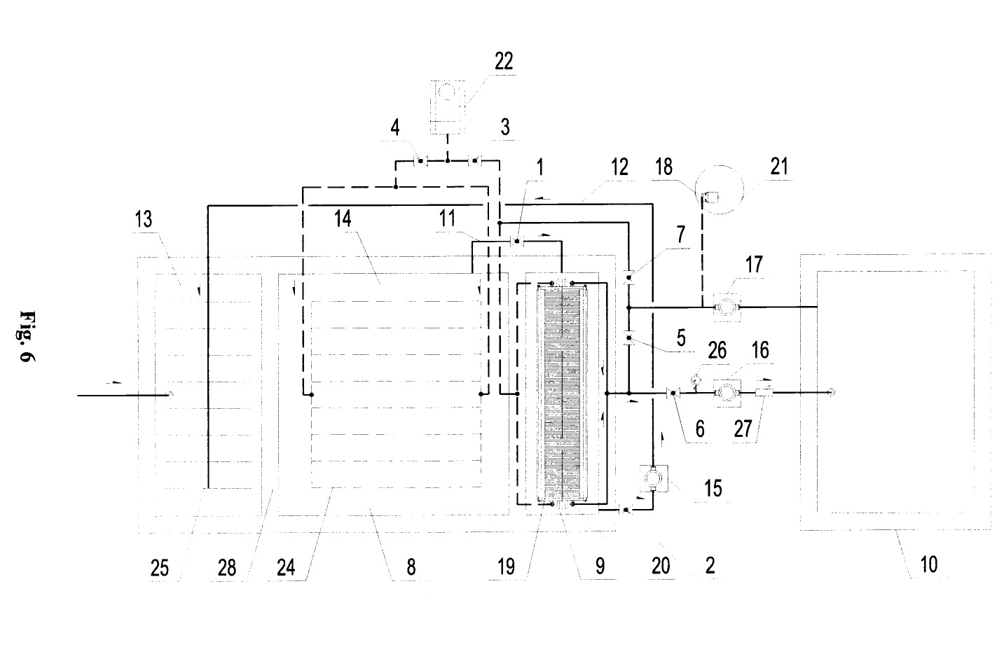

As shown in FIGS. 3 and 6, a wastewater treatment device is provided, most structures of which are the same as the first embodiment, except that a partition wall 28 is provided inside the biological reaction tank 8, and the partition wall 28 divides the biological reaction tank 8 into two separate parts which are interconnected only by the top portion of the partition wall 28, i.e., an anoxic zone 13 and an oxic zone 14 whose volume ratio is 1:3. The bottom of the partition wall 28 is integral with a bottom plate of the biological reaction tank 8 and no apertures are provided in the wall. The top is 200 mm away from the water level. The water distribution device 25 installed at the bottom of the biological reaction tank 8 is located only in the anoxic zone 13, and the gas distribution device 24 installed in the biological reaction tank 8 is located only in the oxic zone 14. The membrane separation device 19 and the blower 22 are both the same as those of the second embodiment.

When the raw water is common domestic wastewater, main indexes of water quality are as follows: pH=6-9, COD_{Cr}=400-500 mg/L, BOD₅=200-300 mg/L, SS=100-300 mg/L, ammonia nitrogen=20-60 mg/L, TN=30-80 mg/L.

For the type described above of wastewater, the wastewater treatment device of the invention can reach a treatment capacity of 20.8 m³/h and a treatment scale of 500 m³/day. The hydraulic retention time of the biological reaction tank 8 is about 4.7 hours, mixed liquor suspended solids (MLSS) thereof is 5-8 g/L, volume load thereof is 1.0-1.5 kg-BOD₅/(m³·d), sludge load thereof is 0.13-0.21 kg-BOD₅/(kg-MLSS·d). The hydraulic retention time of the membrane filter tank 9 is about 1 h, the overall hydraulic retention time of the biological reaction tank 8 and the membrane filter tank 9 is about 5.7 h, and the hydraulic retention time of the produced water storing tank 10 is about 2.2 h.

As shown in FIG. 8, when the wastewater treatment device of the invention is operating, the system charges and discharges water continuously; in the biological reaction tank 8, the anoxic zone 13 is in the anoxic state, and the oxic zone 14 is in the aerobic state. Therefore, it is an anoxic-aerobic (A/O) biologically denitrification reactor in which the anoxic state and the aerobic state are divided spatially, wherein the aeration amount is 67.8 m³/h and the ratio of gas to water is 3.3:1. The aeration takes place continuously in the membrane filter tank 9, wherein the aeration amount is 127.2 m³/h and the ratio of gas to water is 6.1:1. The overall aeration amount of the biological reaction tank 8 and the membrane filter tank 9 is 195 m³/h, and the overall ratio of gas to water is 9.4:1.

Wastewater first enter the lower portion of the anoxic zone 13 of the biological reaction tank 8, and sufficiently contacts activated sludge mixed liquor under the effect of turbulent flow provided by the water distribution device 25. Denitrobacteria, by means of a part of organic substrate, further converts nitrate nitrogen brought by concentrate which has flowed back from the membrane filter tank 9 into nitrogen gas which then escapes from water, thereby realizing removal of total nitrogen. A part of organisms that are hard to degrade also undergo hydrolysis to some extent in the anoxic zone 13. Mixed liquor in the anoxic zone 13 falls into the oxic zone 14 over the top of the partition wall 28. In the oxic zone, activated sludge mixed liquor is in the aerobic state, the aerobic heterotrophic bacteria will further biologically degrade organic substrate, while nitrobacteria will convert ammonia nitrogen in wastewater into nitrate nitrogen. Then, activated sludge mixed liquor inside the oxic zone 14 enters the membrane filter tank 9 via the feed-liquid supply pipe 11. A solid/liquid separation of activated sludge mixed liquor inside the membrane filter tank 9 can be thoroughly realized due to highly efficient separation of the membrane separation device 19. Produced water formed by permeating membrane gradually converges to permeated liquid outlet 20, then conveyed to the produced water storing tank 10 by the outflow pump 16. Compressed air provided by the blower 22 diffuses out through a gas distribution device 23 inside the membrane filter tank 9, and directly washes the root portion of the hollow fiber membrane bundle, so as to effectively prevent sludge gathering at the root portion of the membrane bundle and inhibit the development of membrane fouling at an appropriate level. Concentrate inside the membrane filter tank 9, after pressurized by the circulating pump 15, finally enters the water distribution device 25 installed at the bottom of the biological reaction tank 8 via the feed-liquid backflow pipe 12, and diffuses out through water distribution apertures of the water distribution device 25 to re-mix with activated sludge mixed liquor inside the anoxic zone 13. Meanwhile, oxygen-enriched water formed by high intensity aeration inside the membrane filter tank 9 is brought back to the anoxic zone 13, thus avoiding the problem of dissolved oxygen loss caused when concentrate flows directly to the oxic zone 14 from the top of the membrane filter tank 9. Dissolved oxygen in the anoxic zone 13 is mainly provided by concentrate which has flowed back from the membrane filter tank 9, the biological reaction tank gas supply valve 4 is always in an open state, and the gas distribution device 24 operates continuously, but provides oxygen gas only to the oxic zone 14 of the biological reaction tank 8.

After being treated by the wastewater treatment device of the invention, main indexes of produced water are as follows: COD_{Cr}=20-30 mg/L, BOD₅=1-5 mg/L, SS=0 mg/L, ammonia nitrogen=0.1-1 mg/L, TN=5-10 mg/L, and the removal rates are respectively as follows: COD_{Cr}≧94%, BOD₅≧96%, SS=100%, ammonia nitrogen≧98%, TN≧80%.

The wastewater treatment equipment and process provided by the invention has been described in detail above. Particular embodiments have been used to set forth the principle and implementing mode of the invention in the description. It is obvious to those skilled in the art to, based on the ideas of the invention, realize variations of the particular embodiments and applicable scopes during the implementation. Therefore, the contents recorded in the description should not be considered as limiting the invention.

1. A wastewater treatment equipment, comprising a biological reaction tank and a membrane separation device, wherein the membrane separation device is provided outside the biological reaction tank, a mixing device is provided inside the biological reaction tank and an aeration device is provided inside the membrane separation device or inside a container for accommodating the membrane separation device, the membrane separation device or the container for accommodating the membrane separation device is connected to the biological reaction tank through a pipeline.

2. The wastewater treatment equipment according to claim 1, wherein the membrane separation device is provided inside a membrane filter tank which is independent from the biological reaction tank, and the membrane filter tank is connected to the biological reaction tank through the pipeline.

3. The wastewater treatment equipment according to claim 1, wherein the membrane separation device has an enclosed housing, a feed-liquid inlet and feed-liquid outlet, the feed-liquid inlet and the feed-liquid outlet are connected to the biological reaction tank through the pipeline.

4. The wastewater treatment equipment according to claim 1, wherein there are two said pipelines, one of which is connected to an upper portion of the biological reaction tank, and the other of which is connected to a lower portion of the biological reaction tank.

5. The wastewater treatment equipment according to claim 1, wherein there are two said pipelines, one of which is connected to the biological reaction tank at an upstream of water flow direction inside the biological reaction tank, and the other of which is connected to the biological reaction tank at a downstream of water flow direction inside the biological reaction tank.

6. The wastewater treatment equipment according to claim 1, wherein the mixing device is a water distribution device.

7. The wastewater treatment equipment according to claim 6, wherein the water distribution device is a branch or annular shape water pipe network composed of a plurality of perforated pipes.

8. The wastewater treatment equipment according to claim 6, wherein the water distribution device is located at a lower portion of the biological reaction tank.

9. The wastewater treatment equipment according to claim 1, wherein the mixing device is an agitating device.

10. The wastewater treatment equipment according to claim 9, wherein the agitating device is a submersible agitator.

11. The wastewater treatment equipment according to claim 9, wherein the agitating device is a vertical agitator.

12. The wastewater treatment equipment according to claim 1, wherein the mixing device is a mechanical aeration device.

13. The wastewater treatment equipment according to claim 12, wherein the mechanical aeration device is a rotating brush aerator or a rotating disc aerator.

14. The wastewater treatment equipment according to claim 12, wherein the mechanical aeration device is a vertical surface aerator.

15. The wastewater treatment equipment according to claim 12, wherein the mechanical aeration device is a submersible aerator.

16. The wastewater treatment equipment according to claim 1, wherein an aeration device is provided inside the biological reaction tank.

17. The wastewater treatment equipment according to claim 16, wherein the aeration device inside the biological reaction tank is located at a lower portion of the biological reaction tank, a straight line ascending distance of gas discharged from the aeration device inside the biological reaction tank is larger than one half of the effective water depth of the biological reactive tank.

18. The wastewater treatment equipment according to claim 16, wherein a partition wall is provided in the biological reaction tank, and divides the biological reaction tank into two areas, the mixing device and the aeration device inside the biological reaction tank are located in a different one of the two areas respectively.

19. The wastewater treatment equipment according to claim 16, wherein two partition walls are provided in the biological reaction tank, and divide the biological reaction tank into three areas, the mixing device and the aeration device inside the biological reaction tank are located in a different one of the three areas respectively.

20. The wastewater treatment equipment according to claim 1, wherein a circulating pump is provided in the pipeline.

21. The wastewater treatment equipment according to claim 1, wherein an outflow pump is provided in a pipeline connected to a permeated liquid outlet of the membrane separation device.

22. The wastewater treatment equipment according to claim 1, wherein the membrane separation device comprises a plurality of hollow fiber type membrane modules, plate and frame type membrane modules or tube type membrane modules.

23. The wastewater treatment equipment according to claim 22, wherein the membrane module is a microfiltration membrane, ultrafiltration membrane or nanofiltration membrane.

24. A wastewater treatment process, including the following steps:
a) directing wastewater which is to be treated into a biological reaction tank which has active microorganism therein;
b) directing a mixed liquor composed of the wastewater and active microorganism in the biological reaction tank into a membrane separation device or a container for accommodating the membrane separation device to perform a solid-liquid separation operation on the active microorganism and water, an aeration device provided inside the membrane separation device or the container for accommodating the membrane separation device aerating the mixed liquor during the solid-liquid separation operation;
c) directing a concentrate generated inside the membrane separation device or the container for accommodating the membrane separation device during the solid-liquid separation operation into the biological reaction tank, a mixing device provided inside the biological reaction tank uniformly mixing the concentrate with the mixed liquor inside the biological reaction tank.
